(19) United States
(12) Patent Application Publication
(10) Pub. No.: US 2002/0116324 A1
(43) Pub. Date: Aug. 22, 2002

(54) Debit - credit bank card

(76) Inventor: Carlos G. Macias, Downey, CA (US)

Correspondence Address: ROBERT M. SPERRY, ESQ., 23390 OSRTRONIC DRIVE, WOODLAND HILLS, CA, 91367, US

(21) Appl. No.: 09/789,908

(22) Filed: Feb. 22, 2001

(51) Int. Cl. G06F 17/60

(52) U.S. Cl. 705/38

(57) ABSTRACT

An improved bank card which establishes an individual line of credit for each customer, as a result of agreement between the customer and the bank, and which serves to access the customers's checking and savings accounts in a manner defined by the customer before tapping into the line of credit. In essence, a combination of the features of a debit and credit card wrapped into one card.

### FIELD OF INVENTION

This invention relates to bank cards and is particularly directed to improved bank cards which combine the features of debit cards and credit cards into a single card which can access a customer's line of credit whenever the checking account balance falls below a desired amount.

### PRIOR ART

Banks have long been issuing credit and debit cards for use at ATM machines, stores and the like to relieve clients from the necessity of finding a bank and waiting in long lines to accomplish many transactions. Normally, these cards charge the requested transaction to either a credit card charge account or to the customer's debit card account, depending upon the type of card issued, either a debit card or a credit card. A debit card allows the customer to access funds via an ATM machine or to charge expenses against the customer's checking account. Prior art credit cards do not access a checking account. Instead, they create a charge account with a stated rate of interest which accrues on the unpaid balance. Somebanks offer debit cards, but outsource their credit cards. Other banks offer credit cards, but do not necessarily offer debit cards. However, this requires most customers to carry a credit card issued by one bank and a debit card issued by another bank. Banks currently offer a crude line of credit called “overdraft protection”, This was designed solely to cover overdrafts on the customer's checking account. The system gives the same credit to everyone, but only at a very high interest rate. Thus, none of the prior art credit or charge cards have been entirely satisfactory.

### BRIEF SUMMARY AND OBJECTS OF INVENTION

These disadvantages of the prior art are overcome with the present invention and an improved bank card is provided which allows each customer to establish an individual line of credit and to define the circumstances when that line of credit will be tapped into, thereby enabling the customer to draw on liquid assets in checking or savings accounts, before tapping into the line of credit which entails a higher interest rate. At the same time, the card enables the bank the increase profits by determining the risk for each customer individually and applying the appropriate interest rate, instead of passing such interest to a finance company.

The advantages of the present invention are preferably attained by providing an improved bank card which establishes an individual line of credit for each customer, as a result of agreement between the customer and the bank, and which serves to access the customers's checking and savings accounts in a manner defined by the customer before tapping into the line of credit.

Accordingly, it is an object of the present invention to provide an improved bank card. Which allows each customer to establish an individual line of credit.

Another object of the present invention is to provide an improved bank card which allows the customer to define the circumstances when that line of credit will be tapped into.

A further object of the present invention is to provide an improved bank card which enables the customer to draw on liquid assets in checking or savings accounts before tapping into the line of credit which entails a higher interest rate.

A further object of the present invention is to provide an improved bank card which enables the bank to increase profits by determining the risk for each customer individually and applying the appropriate interest rate, instead of passing such interest to a finance company.

Another object of the present invention is to provide an improved bank card which can access substantially any desired combination of accounts.

A specific object of the present invention is to provide an improved bank card which establishes an individual line of credit for each customer, as a result of agreement between the customer and the bank, and which serves to access the customers's checking and savings accounts in a manner defined by the customer before tapping into the line of credit.

These and other objects and features of the present invention will be apparent from the following detailed description, taken with reference to the figures of the accompanying drawing.

### BRIEF DESCRIPTION OF THE DRAWING

FIG. 1 is a flow diagram showing the programming and use of the bank card of the present invention

### DETAILED DESCRIPTION OF THE INVENTION

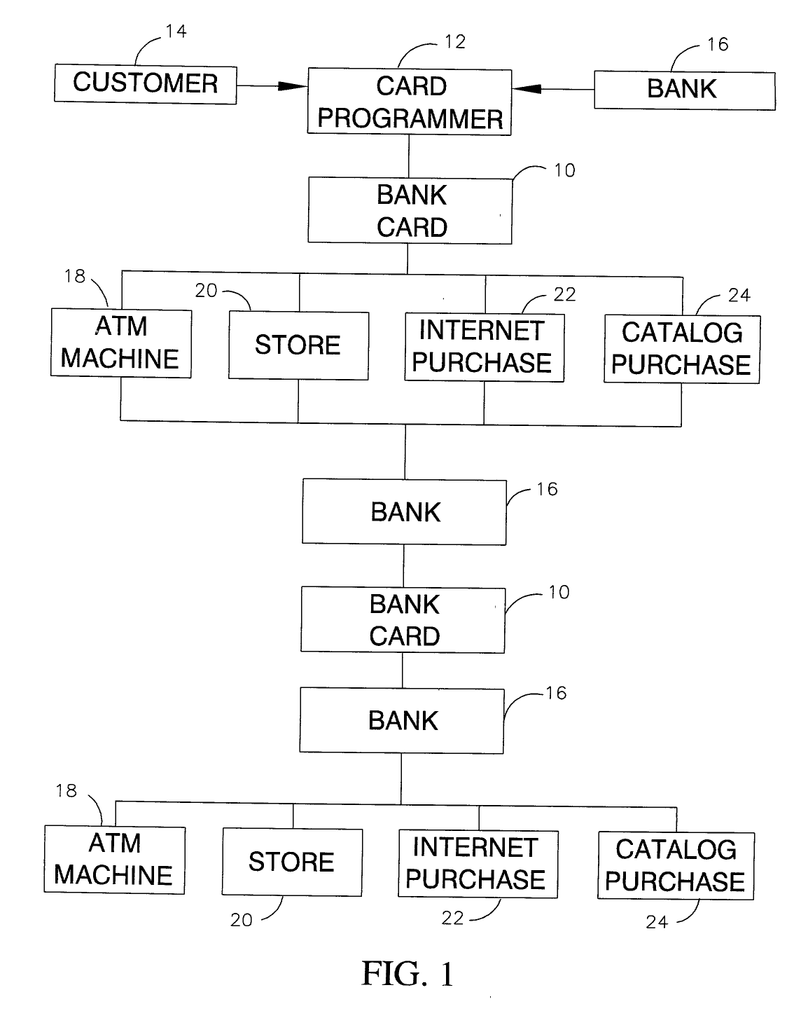

In that form of the present invention chosen for purposes of illustration, FIG. 1, shows a bank card, indicated generally at 10. As seen in FIG. 1, the bank card 10 is programmed at 12 by inputs from both the customer 14 and the bank 16 to indicate which of the customer's accounts are to be the primary, secondary and tertiary sources of funds for transactions made with the bank card 10 and the circumstances under which the line of credit is to be tapped. At the same time, the bank can determine the risk for each customer on an individual basis and apply an appropriate rate of interest for the line of credit which is substantially higher than the rate paid on checking or savings accounts, yet is considerably lower that the rates normally charged for the unpaid balances of conventional credit card accounts. Thereafter, when the customer 14 uses the bank card for transactions at an ATM machine 18, store 20, Internet purchase 22, catalogue purchase 24 or the like, the bank card 10 instructs the charging machine 18, 20, 22 or 24 to charge the transaction, first, to the primary source selected by the customer. If the balance in the desired account is insufficient to cover the transaction, the bank 16 will notify the charging machine 18, 20, 22 or 24; whereupon, the bank card 10 instructs the charging machine 18, 20, 22 or 24 to apply the overage of the transaction to the secondary account, etc. and, finally, to tap the pre-established line of credit. It will be seen that any type of account can be used by the customer 14, subject to the rules and regulations of the bank 16 and its governing agencies. This provides the customer 14 with the maximum possible control and flexibility in the use of their money. Also, the bank can evaluate the risk for each customer, on an individual basis, and can determine the appropriate rate of interest for the line of credit. This enables the bank to maximize its income and minimize its risk.

Obviously, numerous variations and modifications can be made without departing from the spirit of the present invention. Therefore, it should be clearly understood that the forms of the present invention described above and shown in the figure of the accompanying drawing are illustrative only and are not intended to limit the scope of the present invention.

What is claimed is:

1. A bank card comprising:
a card programmed by inputs from a customer and the customer's bank and serving to establish a line of credit for the customer based upon the banks's risk assessment for that individual.

2. The bank card of claim 1 wherein:
said card serves to direct transactions to a plurality of the customer's accounts in a sequence selected by said customer.

3. The bank card of claim 1 wherein:
said card is programmed to apply charges first to the customer's primary account of choice.

4. The bank card of claim 1 wherein:
said bank card is responsive to an overdraft notice from said bank to reapply said transaction to the customer's secondary account.

5. The bank card of claim 1 wherein:
said card is responsive to said overdraft notice to reapply said transaction to said line of credit.
